(19) United States
(12) Patent Application Publication
(10) Pub. No.: US 2003/0027477 A1
(43) Pub. Date: Feb. 6, 2003

(54) Manufacturing method of christmas lamp bulb with multiple light spots

(76) Inventor: Wen-Ting Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/262,977

(22) Filed: Oct. 3, 2002

Related U.S. Application Data
(63) Continuation-in-part of application No. 09/558,874, filed on Apr. 28, 2000.

(51) Int. Cl. H01J 9/24

(52) U.S. Cl. 445/22; 65/108

(57) ABSTRACT

A manufacturing method of Christmas lamp bulb with multiple light spots is proposed. The upper half of a glass pipe is processed by blowing to form a bulb body, and a bulb head is simultaneously formed at the top end of the bulb body by blowing. Next, a mold is used for the step of integral die-casting to form various kinds of strips and patterns on the surface of the bulb body. A light-emitting device is then installed in the bulb body. Subsequently, air in the bulb body is extracted out to vacuate the inside of the bulb body. Finally, a sealing operation is performed to the bulb body to finish a Christmas lamp bulb. Through modification of the surface structure, diversified lighting effects can be produced to effectively set off a string of lamps, hence achieving a better decorative effect.

### FIELD OF THE INVENTION

The present invention relates to a Christmas lamp bulb and, more particularly, to a manufacturing method of a modified surface structure of Christmas lamp bulb.

### BACKGROUND OF THE INVENTION

Along with the increasing enhancement of living standard, people have been more and more appreciating the savor of living. Therefore, some occasional decorations are usually disposed, and there are many different celebration activities. For instance, to greet the advent of the Christmas, some strings of Christmas lamps are disposed on trees to decorate them as Christmas trees.

These diversified Christmas illuminations cannot get rid of conventional lamp bulbs. A conventional lamp bulb is comprised of two lead wires, whose top ends are connected together with a tungsten filament. A glass pipe covers the tungsten filament and the upper sections of the lead wires, and is then sealed up. However, the bore of the glass pipe of a conventional lamp bulb is smaller, resulting in difficult spread of heat. Therefore, only lamp bulbs of smaller amperages can be manufactured, hence providing much limited brightness.

In the disclosure of U.S. Pat. No. 5,590,952, various kinds of patterns of different colors are painted on the surface of a lamp bulb body. In the disclosure of U.S. Pat. No. 2,043,925, paints of different colors are injected onto inner and outer surfaces of glass pipes of lamp bulbs during manufacturing to produce lamp bulb bodies of different patterns. Although these two disclosures can generate different color effects, except for variation of colors, the uniformity of the emitted lamp lights are all the same. There is no special effect, and the produced lighting effect has no variation.

Accordingly, the present invention aims to propose a manufacturing method of Christmas lamp bulb with multiple light spots to effectively solve the problems in the prior art.

### SUMMARY AND OBJECTS OF THE PRESENT INVENTION

The primary object of the present invention is to provide a manufacturing method of Christmas lamp bulb with multiple light spots, wherein the surface structure of the lamp bulb body is modified to generate different strips and patterns, letting refractive light spots be more and also having focusing and scattering functions so that the light bulb can have diversified lighting effects.

Another object of the present invention is to provide a manufacturing method of Christmas lamp bulb with multiple light spots, whereby Christmas lamp bulbs with identical or similar patterns can match a string of lamp bulbs of any shape to effectively set off the string of lamp bulb so as to achieve a better decorative effect.

To achieve the above objects, the present invention provides a manufacturing method of Christmas lamp bulb with multiple light spots. A glass pipe is first provided. The upper half of the glass pipe is processed by blowing to form a bulb body, and a bulb head is simultaneously formed at the top end of the bulb body by blowing. Next, a mold is used for the step of integral die-casting to form various kinds of strips and patterns on the surface of the bulb body. A light-emitting device is then installed in the bulb body. Subsequently, air in the bulb body is extracted out to vacuate the inside of the bulb body. Finally, a sealing operation is performed to the bulb body.

The various objects and advantages of the present invention will be more readily understood from the following detailed description when read in conjunction with the appended drawings, in which:

### BRIEF DESCRIPTION OF DRAWING

FIGS. 1(a) to 1(e) show the manufacturing flowchart of the present invention; and

FIGS. 2 to 5 show various kinds of embodiments of the present invention.

### DETAILED DESCRIPTION OF PREFERRED EMBODIMENT

The present invention makes use of processing of the surface structure to form different strips and patterns on the surface of a lamp bulb so as to exactly produce different lighting effects with light spots.

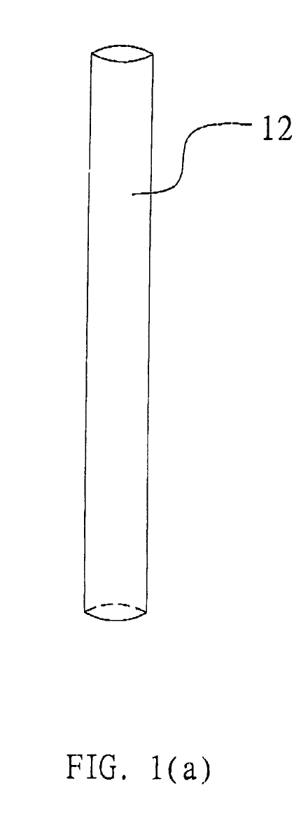

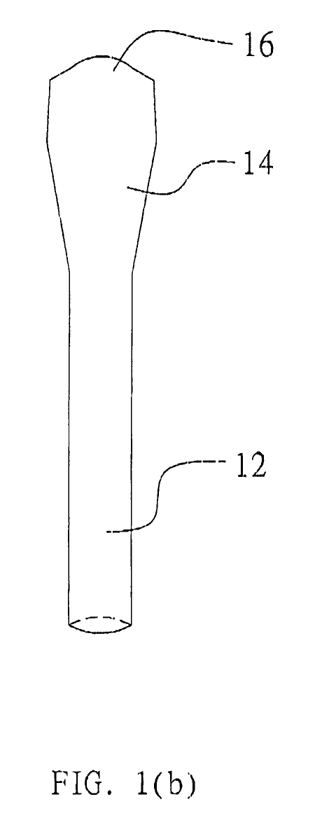

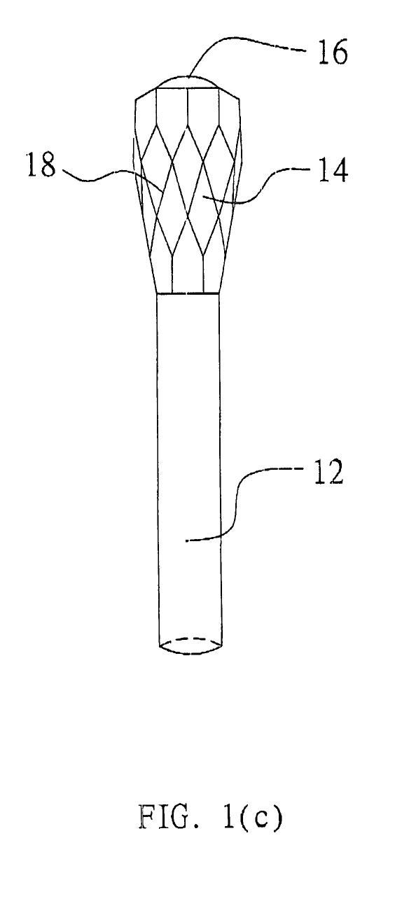

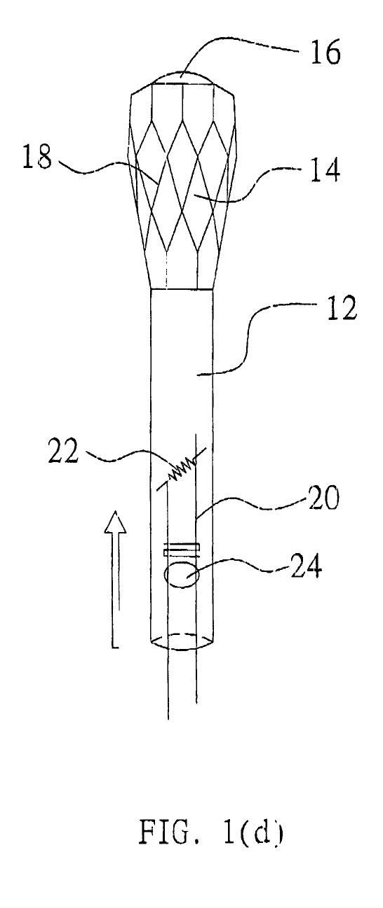

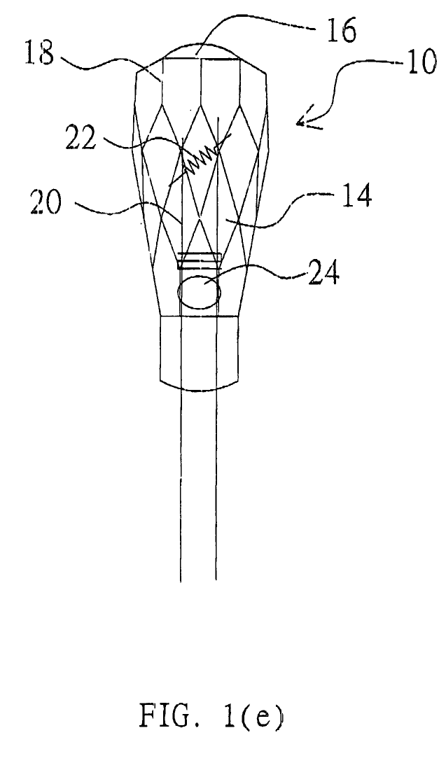

FIGS. 1(a) to 1(e) show the manufacturing flowchart of a Christmas lamp bulb 10 with multiple light spots of the present invention. As shown in FIG. 1(a), a glass pipe 12 with a bore of 5.2 mm is first provided. As shown in FIG. 1(b), the upper half of the glass pipe 12 is processed by blowing to form a bulb body 14 of diameter 8 mm, and a bulb head 16 of diameter 5.2 mm is simultaneously formed at the top end of the bulb body 14 by blowing. During the production process, if various kinds of stripped patterns 18 are directly added on the glass pipe 12, the production is impossible. This is because after the stripped pattern is formed, cracking or melting will occur on the stripped pattern when the bulb body is processed to form a lamp bulb. Therefore, in the present invention, flames on a sealing machine are increased during the production process, and the baking time is lengthened. Moreover, a mold is used for integral die-casting of the bulb body 14 to form various kinds of stripped patterns 18 on the surface of the bulb body 14, as shown in FIG. 1(c). As shown in FIG. 1(d), a light-emitting device is then placed into the bulb body 14 from the bottom of the glass pipe 12 and through the glass pipe 12. As shown in FIG. 1(e), air in the bulb body 14 is then extracted out to vacuate the inside of the bulb body, and a sealing operation is finally performed to the bulb body to obtain a Christmas lamp bulb.

The light-emitting device is composed of two lead wires 20. A tungsten filament 22 is disposed at the top ends of the two lead wires 20. A fixing piece 24 is also disposed at the middle part of the two lead wires 20.

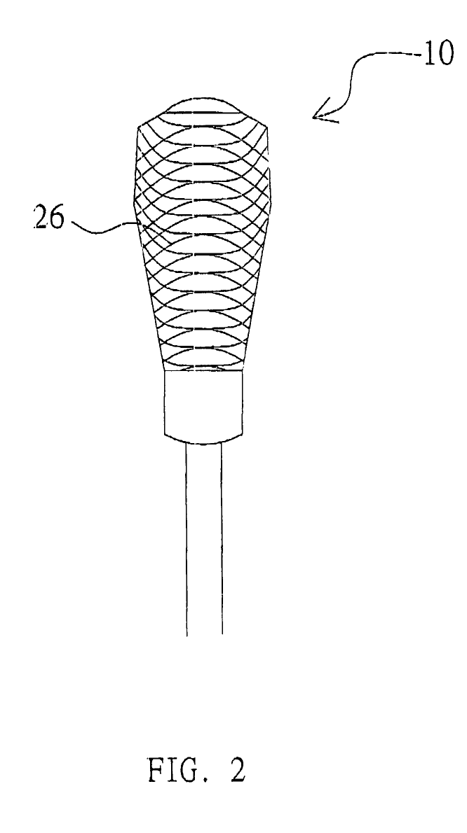

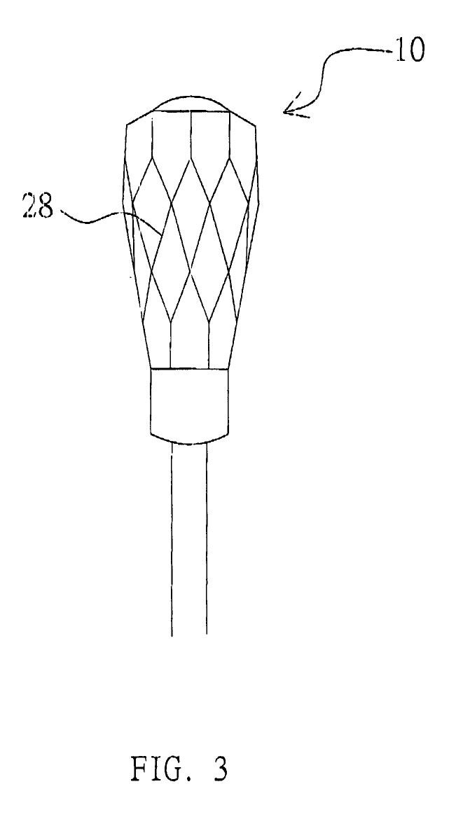

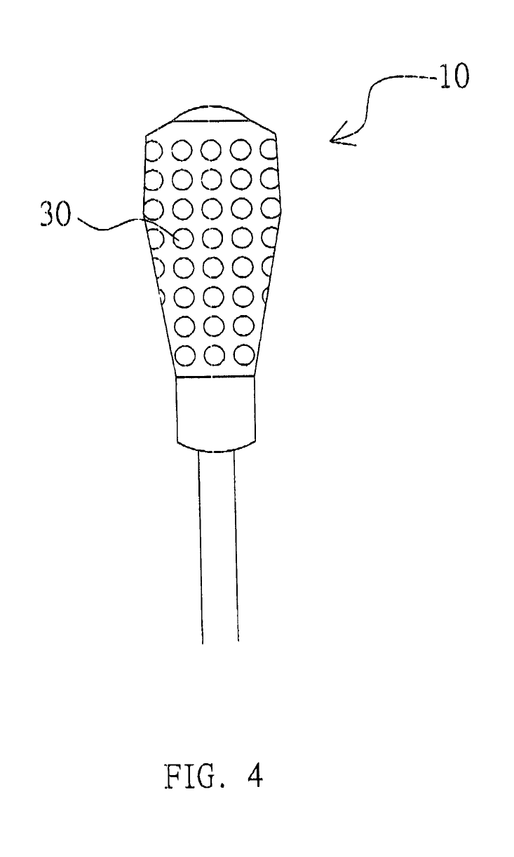

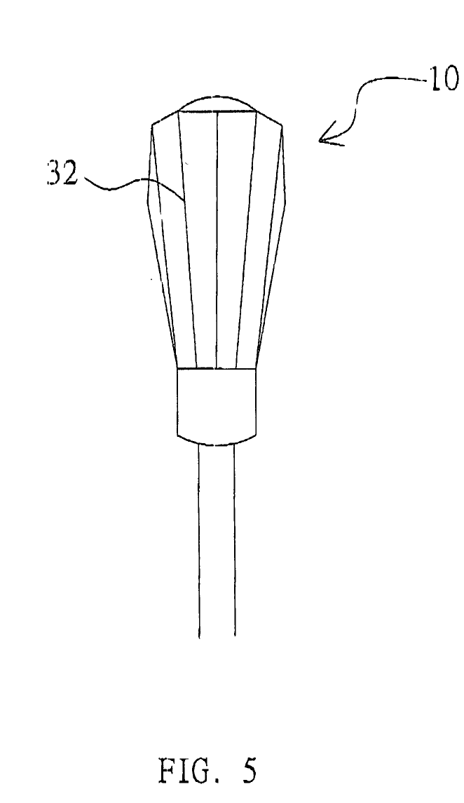

FIGS. 2 to 5 show various kinds of embodiments of the present invention, wherein all the lamp bulbs are mini lamp bulbs of diameters about 8˜10 mm and lengths about 30 mm. A cylindrical lamp bulb with crossed strips 26 is shown FIG. 2, wherein visually the crossed strips 26 will let each crossed point be a light focusing point so that the whole lamp bulb will form a small light spot. A cylindrical lamp bulb with meshed strips 28 is shown FIG. 3, wherein the meshed strips 28 will have a light-scattering effect so that the lamp light will be softer than that of a common light bulb. A lamp bulb with spot-like strips 30 is shown FIG. 4, wherein a plurality of spots will refract light into very dense small light spots and simultaneously also have light focusing and scattering effects. A cylindrical lamp bulb with straight strips 32 is shown FIG. 5, wherein the straight strips 32 will let light become a grid-shaped light.

The conventional tungsten filament of diameter 0.21 mm can be replaced with a tungsten filament of diameter larger than 0.28 mm to have higher brightness and safer use. The circular tip of the conventional lamp bulb can further be changed to a flattop shape to be more delicate and safer. Moreover, the flattop shape can become a light focusing point to let the emitted light be brighter. In addition to the above strips, the surface strips can be oblique strips, needle-like strips, wave-like strips, star-like strips, or other unmentioned strips.

Therefore, the present invention makes use of modified surface structure of a lamp bulb body to produce different stripped patterns so as to have more refracted light spots and have also light focusing and scattering effects, hence letting the light bulb show diversified lighting effects. Moreover, each different design can generate a unique style. Christmas lamp bulbs with identical or similar patterns can match a string of lamp bulbs of any shape to effectively set off the string of lamp bulb so as to achieve a better decorative effect. Besides, when the present invention is installed on the wall, light of the Christmas lamp bulbs can be scattered by the wall to have scattered light in addition to the original light of the lamp bulb itself. Through mutual setting off by contrast of these two kinds of lights, a better mood can be built.

Although the present invention has been described with reference to the preferred embodiments thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A manufacturing method of Christmas lamp bulb with multiple light spots, comprising the steps of:
providing a glass pipe, blowing an upper half of said glass pipe into a bulb body, and simultaneously blowing a bulb head at a top end of said bulb body;
using a mold to perform an integral die casting of said bulb body to form a stripped pattern on a surface of said bulb body;
installing a light emitting device in said bulb body;
extracting air in said bulb body out to vacuate the inside of said bulb body; and
performing a sealing operation to said bulb body.

2. The manufacturing method of Christmas lamp bulb with multiple light spots as claimed in claim 1, wherein said light emitting device comprises two lead wires, a tungsten filament is disposed at top ends of said two lead wires, and a fixing piece is fixed at a middle part of said two lead wires.

3. The manufacturing method of Christmas lamp bulb with multiple light spots as claimed in claim 1, wherein said bulb head can be of a flattop shape.

4. The manufacturing method of Christmas lamp bulb with multiple light spots as claimed in claim 1, wherein said stripped pattern is selected from strip groups formed of oblique strips, straight strips, crossed strips, meshed strips, spot-like strips, needle-like strips, wave-like strips, and star-like strips.
